(19) United States
(12) Patent Application Publication
(10) Pub. No.: US 2015/0272360 A1
(43) Pub. Date: Oct. 1, 2015

(54) Combined baby bottle, sippy cup, and dry storage container

(71) Applicant: Markeith D. Knowlton, Virginia Beach, VA (US)

(72) Inventor: Markeith D. Knowlton, Virginia Beach, VA (US)

(21) Appl. No.: 14/667,962

(22) Filed: Mar. 25, 2015

Related U.S. Application Data
(60) Provisional application No. 61/970,889, filed on Mar. 26, 2014.

(51) Int. Cl. A47G 19/22; A61J 9/00

(52) U.S. Cl. CPC A47G 19/2272; A61J 9/00

(57) ABSTRACT

A combined baby bottle, sippy cup, and dry storage container holds wet or dry material, and may support a nipple top, sippy top, or closed top on an interchangeable basis. Each top may also be removed, such that the contents may be eaten with fingers or a utensil. A telescoping spoon, suitable for use by a toddler, is stored within the sippy top in a separate chamber. All components are shatterproof and dishwasher safe.

### CROSS-REFERENCE TO RELATED APPLICATIONS

This application claims the benefit of U.S. Provisional Application No. 61/970,889, filed Mar. 26, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to infant and child care accessories, and in particular to a combined baby bottle, sippy cup, and dry storage container. Parents caring for infants and toddlers are frequently challenged by the tasks of daily life, particularly if they are working outside the home or taking classes. As the child matures and transitions from a baby bottle to a sippy cup, and to early solid foods, a broad and confusing array of feeding devices becomes necessary. The frequent and developing process of feeding the infant or toddler, at home or elsewhere, focuses the parents' attention and efforts on an assortment of baby bottles, sippy cups, and small storage containers for dry food. Combining these devices would simplify the process substantially and save these parents valuable time, effort, and money. A combined baby bottle, sippy cup, and dry storage container would resolve this problem.

### SUMMARY OF THE INVENTION

Accordingly, the invention is directed to a combined baby bottle, sippy cup, and dry storage container. The device comprises two separate containers which may be combined together or separated. Each container may hold wet or dry material, and may support a nipple top, sippy top, or closed top on an interchangeable basis. Each top may also be removed, such that the contents may be eaten with fingers or a utensil. A telescoping spoon, suitable for use by a toddler, is stored within the sippy top in a separate chamber. All components are shatterproof and dishwasher safe.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of the first exemplary embodiment in a disassembled state, displaying the first container 10, the finger grooves 10A, the second container 11, the sippy top 12, the sippy mouthpiece 13, the breather 14, the nipple top 15, the nipple 16, the nipple cap 17, and the closed top 19.

FIG. 2 is a front view of the spoon component of the first exemplary embodiment in extended and retracted positions, displaying the spoon 18.

FIG. 3 is a front view of the first exemplary embodiment in a fully assembled state, displaying the first container 10, the finger grooves 10A, the second container 11, the sippy top 12, the nipple top 15, the nipple cap 17, and the sliding door 18.

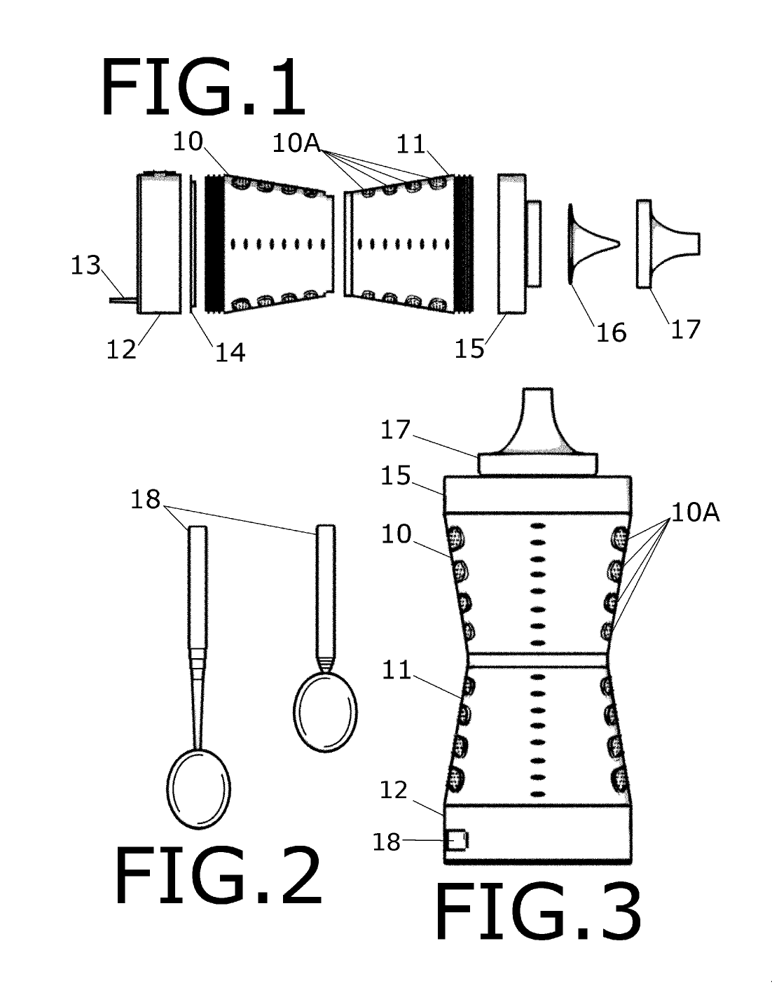

### DETAILED DESCRIPTION OF THE INVENTION

Referring now to the invention in more detail, the invention is directed to a combined baby bottle, sippy cup, and dry storage container. The device comprises two separate containers which may be combined together or separated. Each container may hold wet or dry material, and may support a nipple top 15, sippy top 12, or closed top 19 on an interchangeable basis. Each top may also be removed, such that the contents may be eaten with fingers or a utensil. A telescoping spoon 18, suitable for use by a toddler, is stored within the sippy top 12 in a separate chamber. All components are shatterproof and dishwasher safe.

The first exemplary embodiment comprises a first container 10 and a second container 11. Each of the two containers has a circular cross-section and tapers slightly from the open top end to the closed bottom end. The outer surfaces of the two containers provide a plurality of finger grooves 10A, which are appropriately sized and spaced for the fingers of an infant or toddler. The finger grooves 10A provide a pattern of bumps, ridges, or other protrusions, enabling a secure grip by the child user.

The bottom surface of the first container 10 may be joined easily without external leakage to the bottom surface of the second container 11, employing a twist and click mechanism which is well known to the art. The twist and click mechanism, when activated, enables fluid communication between the two containers. Thus joining the two containers creates a single, larger container. Generically, the two containers may be understood as releasably affixable to one another and configured such that fluid communication is selectively enabled between them.

Either the first container 10 or the second container 11 may support a nipple top 15, sippy top 12, or closed top 19 on an interchangeable basis, releasably affixable thereto. The nipple top 15 provides a flexible nipple 16, a flexible breather 14, and a rigid nipple cap 17, which snaps on top of the nipple 16 to enclose the container, preventing leakage and keeping the nipple 16 clean. The sippy top 12 provides a flexible sippy mouthpiece 13, which may be easily retracted beneath a sliding cover which snaps shut, preventing leakage and keeping the sippy mouthpiece 13 clean. Of particular advantage is the configuration wherein the sippy top 12 and nipple top 15 are simultaneously installed, which allows for two modes of consumption of a single liquid when the first and second containers are in fluid communication, or of two separate liquids when the two containers are not in fluid communication.

A sliding door 18 on the side of the sippy top 12 reveals a chamber, wherein a telescoping spoon 18 is stored. The spoon 18 is configured for passing through said sliding door into a storage position. The spoon 18 is appropriately sized for use by a toddler, and may be used to remove and eat the contents of the container which supports the sippy top 12.

All components are dishwasher safe and shatterproof. The interior surfaces of the first container 10 and the second container 11 are smooth, for the purpose of ease of cleaning.

To use the first exemplary embodiment, the user may join the first container 10 to the second container 11, using the twist and click mechanism which is provided. This creates a larger combined container. One end of the combined container may be used to support either the sippy top 12 or the nipple top 15, while the other end of the combined container may be used to support the closed top 19. In an alternate configuration, the first container 10 and the second container 11 may be used as separate, smaller containers. Each of the two containers may be used to support the sippy top 12, the nipple top 15, or the closed top 19. If both are being used as dry food containers, the sippy top 12 and the closed top 19 should be used. The telescoping spoon 18 may be used to remove and eat the contents of either container.

The first container 10, the second container 11, the sippy top 12, the nipple top 15, the nipple cap 17, and the spoon 18 are preferably manufactured from rigid, durable materials which are dishwasher safe and shatterproof, such as plastic. The sippy mouthpiece 13, the breather 14, and the nipple 16 are preferably manufactured from a flexible, durable material which is dishwasher safe and shatterproof, such as silicone. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A combined baby bottle, sippy cup, and dry storage container comprising:
(a) a first container;
(b) a second container;
(c) said first container and said second container being releasably affixable to one another;
(d) said first container and said second container being configured such that fluid communication is selectively enabled between said first container and said second container;
(e) a nipple top;
(f) a sippy top;
(g) a closed top;
(h) said nipple top, said sippy top, and said closed top each being releasably affixable to said first container or said second container on an interchangeable basis.

2. The combined baby bottle, sippy cup, and dry storage container of claim 1 wherein said nipple top and said sippy top are simultaneously installed.

3. The combined baby bottle, sippy cup, and dry storage container of claim 1 further comprising a spoon; a sliding door; said sliding door being located on the side of said sippy top; said spoon being collapsible; and said spoon being configured for passing through said sliding door into a storage position.

4. The combined baby bottle, sippy cup, and dry storage container of claim 2 further comprising a spoon; a sliding door; said sliding door being located on the side of said sippy top; said spoon being collapsible; and said spoon being configured for passing through said sliding door into a storage position.

5. The combined baby bottle, sippy cup, and dry storage container of claim 1 wherein said sippy top comprises a mouthpiece; said mouthpiece being flexible and retractable.

6. The combined baby bottle, sippy cup, and dry storage container of claim 2 wherein said sippy top comprises a mouthpiece; said mouthpiece being flexible and retractable.

7. The combined baby bottle, sippy cup, and dry storage container of claim 3 wherein said sippy top comprises a mouthpiece; said mouthpiece being flexible and retractable.

8. The combined baby bottle, sippy cup, and dry storage container of claim 4 wherein said sippy top comprises a mouthpiece; said mouthpiece being flexible and retractable.

9. The combiner baby bottle, sippy cup, and dry storage container of claim 1 wherein the outer surface of said first container and the outer surface of said second container provide a plurality of finger grooves.

10. The combiner baby bottle, sippy cup, and dry storage container of claim 2 wherein the outer surface of said first container and the outer surface of said second container provide a plurality of finger grooves.

11. The combiner baby bottle, sippy cup, and dry storage container of claim 3 wherein the outer surface of said first container and the outer surface of said second container provide a plurality of finger grooves.

12. The combiner baby bottle, sippy cup, and dry storage container of claim 4 wherein the outer surface of said first container and the outer surface of said second container provide a plurality of finger grooves.

13. The combiner baby bottle, sippy cup, and dry storage container of claim 5 wherein the outer surface of said first container and the outer surface of said second container provide a plurality of finger grooves.

14. The combiner baby bottle, sippy cup, and dry storage container of claim 4 wherein the outer surface of said first container and the outer surface of said second container provide a plurality of finger grooves.

15. The combiner baby bottle, sippy cup, and dry storage container of claim 5 wherein the outer surface of said first container and the outer surface of said second container provide a plurality of finger grooves.

16. The combiner baby bottle, sippy cup, and dry storage container of claim 6 wherein the outer surface of said first container and the outer surface of said second container provide a plurality of finger grooves.

17. The combiner baby bottle, sippy cup, and dry storage container of claim 7 wherein the outer surface of said first container and the outer surface of said second container provide a plurality of finger grooves.

18. The combiner baby bottle, sippy cup, and dry storage container of claim 8 wherein the outer surface of said first container and the outer surface of said second container provide a plurality of finger grooves.
